(19) United States
(12) Patent Application Publication
(10) Pub. No.: US 2006/0180457 A1
(43) Pub. Date: Aug. 17, 2006

(54) Sliding mechanism for use with portable electronic device and method of operating the same

(76) Inventors: Young-Soo Han, Anyang-Si (KR); Seong Sik Kang, Hwaseong-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/343,930

(22) Filed: Jan. 31, 2006

(30) Foreign Application Priority Data
Feb. 1, 2005 (KR) 20-2005-3077

(51) Int. Cl. H01H 15/06

(52) U.S. Cl. 200/550

(57) ABSTRACT

A sliding mechanism device and its application to a portable electronic device are disclosed. The device includes a first sliding member attached to a first unit of the electronic device and a second sliding member attached to the second unit of the electronic device. The second sliding member is slidably coupled to the first sliding to slide relative to the first sliding member between first and second positions with help of springs connected to the first and second sliding members. The first and second positions of the second sliding member correspond to open and closed positions of the first and second units of the electronic device.

### BACKGROUND

1. Field

The present invention pertains to a sliding mechanism device, and more specifically to application of the device in portable electronic devices.

2. Description of the Related Technology

Referring to FIG. 10, there is schematically shown a conventional slide type opening and closing device or sliding mechanism device implemented in a mobile phone. As shown in FIG. 10, the mobile phone 12a includes a first unit 14a and a second unit 16a illustrated in dotted lines. The first unit 14a is usually provided with a keypad and the second unit 16a has a liquid crystal display. The first unit 14a and the second unit 16a are moveably coupled together by means of an opening and closing device or sliding mechanism 10a. The sliding mechanism 10a includes a support member 20a fixedly secured to the first unit 14a, a pair of moving rods 40a respectively attached to opposite side parts of the second unit 16a and serving as sliders, and a torsion spring 50a. Although not shown in detail, guide rails are provided at opposite side parts of the support member 20a. The moving rods 40a are brought into engagement with the guide rails for linear movement therealong. The torsion spring 50a has a couple of distal ends respectively affixed to the support member 20a and one of the moving rods 40a. As the moving rods 40a are subject to linear movement along the guide rails of the support member 20a, the keypad of the first unit 14a is either exposed to the outside or closed out of view. At the end of forced movement for a short span, the second unit 16a is moved automatically to open or close the key pad under the action of the torsion spring 50a.

Durability is demanded in the above-noted and other sliding mechanisms for mobile phones. Among other components of the sliding mechanisms, a spring requires durability great enough to assure failure-free reiterated operations. The sliding mechanisms should also be capable of performing their operations in a precise and accurate manner. In addition, the sliding mechanisms should be as thin and compact as possible for adaptation to portable products, such as mobile phones, that have a tendency to become smaller and smaller. In the prior art sliding mechanisms, a spring is directly coupled to a couple of sliding members, thus generating an unwanted noise at the coupling parts.

### SUMMARY OF CERTAIN INVENTIVE ASPECTS

One aspect of the invention provides a device comprising a sliding mechanism configured to interconnect a first unit and a second unit such that the first and second units can slide with reference to the other. The sliding mechanism comprises: a first sliding member configured to be secured to the first unit and a second sliding member configured to be secured to the second unit, the second sliding member slidably engaged with the first sliding member and slidable relative to the first sliding member between a first position and a second position. The sliding mechanism further comprises a first spring comprising a first end secured to the first sliding member and a second end secured to the second sliding member, the first spring configured to exert force on the first and second sliding members to spontaneously move away from each other; and a second spring comprising a first end secured to the first sliding member and a second end secured to the second sliding member, the second spring configured to exert force on the first and second sliding members to spontaneously move away from each other. The sliding mechanism has a third position between the first and second positions, wherein the first and second springs are arranged so as to force the second sliding member to spontaneously move toward the first position when the second sliding member is located between the first and third position.

In embodiments of the foregoing device, the first spring second springs may be configured and arranged such that no portions of the first and second springs overlap as the second sliding member moves relative to the first sliding member between the first and second positions. The first spring and the second spring may be configured and arranged such that the first and second springs may be on substantially the same plane as the second sliding member moves relative to the first sliding member between the first and second positions. The first and second springs may be arranged such that the first spring is closer to the first position than the second spring. The first spring may be arranged such that the first end of the first spring may be closer to the first position than the second end of the first spring. At least one of the first and second springs may comprise a torsion spring. The torsion spring may comprise at least two coils. There may be a third position between the first and second positions, wherein the first and second springs may be arranged so as to force the second sliding member to spontaneously move toward the first position when the second sliding member is located between the first and third position, and wherein the first and second springs may be arranged so as to force the second sliding member to spontaneously move toward the second position when the second sliding member is located between the second and third position.

Still in embodiments of the foregoing device, one of the first and second sliding members may comprise a rail, and the other of the first and second sliding members may comprise a guide groove configured to slidably engage with the rail. The first sliding member may comprise a first edge and a second edge substantially parallel to the first edge, wherein the second sliding member may comprise a first edge and a second edge parallel to the first edge of the second sliding member, wherein the first and second sliding members may be engaged such that the first edge of the second sliding member may be substantially parallel to the first edge of the first sliding member and that the first edge of the second sliding member may be located closer to the first edge of the first sliding member. The first end of the first spring may be secured to the first sliding member at a position closer to the first edge of the first sliding member than to the second edge of the first sliding member, and wherein the second end of the first spring may be secured to the second sliding member at a position closer to the second edge of the second sliding member than to the first edge of the second sliding member. The first end of the second spring may be secured to the first sliding member at a position closer to the first edge of the first sliding member than to the second edge of the first sliding member, and wherein the second end of the second spring may be secured to the second sliding member at a position closer to the second edge of the second sliding member than to the first edge of the second sliding member.

In further embodiments, the first end of the first spring may be secured to the first sliding member, wherein the first spring is rotatable about an axis substantially perpendicular to a plane on which the second sliding member may be slidable while the first end does not move relative to the first sliding member on the plane. The axis may be located adjacent to the first end of the spring. The first end of the first spring may be secured to the first sliding member via a coupler, wherein the first end may be secured to coupler, wherein the first sliding member may comprise a post protruding in a direction substantially perpendicular to a plane on which the second sliding member may be slidable relative to the first sliding member, and wherein the coupler may be engaged with the post and rotatable about the direction. At least one of the first and second springs may comprise an undulating portion. The undulating portion may be generally in curved configurations when the second sliding member is at the first or second positions, and wherein the curved configurations may be curved generally in opposite directions. The device may comprise a portable electronic device, wherein at least one of the first and second units may comprise a display, and wherein at least one of the first and second units may comprise an information input device. The device may comprise a portable electronic device selected from the group consisting of a wireless internet device, a mobile phone, a wireless email receiver, a radio receiver, a television receiver, a calculator, an electronic dictionary or encyclopedia, a PDA and a hand-held computer.

Another aspect of the invention provides a method of operating the above described device. The method comprises: providing the device, which has a third position between the first position and second position; and sliding the second unit with reference to the first unit in a first direction, whereby the second sliding member slides with reference to the first sliding member away from the first position and toward the second position. After the sliding if the second sliding member is located between the first position and the third position, the second sliding member spontaneously slides to the first position. After the sliding if the second sliding member is located between the third position and the second position, the second sliding member spontaneously slides to the second position.

In embodiments of the method, wherein the first position may correspond to a closed position of the device, and wherein the second position may correspond to an open position of the device. The method may further comprise: sliding the second unit with reference to the first unit in a second direction opposing the first direction, whereby the second sliding member slides away from the second position and toward the first position, wherein after the sliding if the second sliding member is located between the third position and the second position, the second sliding member spontaneously slides to the second position, wherein after the sliding if the second sliding member is located between the first position and the third position, the second sliding member spontaneously slides to the first position.

A further aspect of the invention provides a portable electronic device. The device comprises: a first electronic unit; a second electronic unit slidably connected to the first electronic unit, wherein at least one of the first and second electronic units comprises a display, and wherein at least one of the first and second electronic units comprises an information input device; and a sliding mechanism interconnecting the first and second electronic units. The sliding mechanism comprises: a first sliding member secured to the first electronic unit, a second sliding member secured to the second electronic unit, the second sliding member slidably engaged with the first sliding member and slidable relative to the first sliding member between a first position and a second position, a first spring comprising a first end secured to the first sliding member and a second end secured to the second sliding member, the first spring configured to exert force on the first and second sliding members to spontaneously move away from each other, and a second spring comprising a first end secured to the first sliding member and a second end secured to the second sliding member, the second spring configured to exert force on the first and second sliding members to spontaneously move away from each other.

According to one aspect of the present invention, there is provided a slide type opening and closing device or a sliding mechanism for combining first and second units together and for causing the second unit to move with respect to the first unit along an axis of movement between a first position and a second position to thereby open or close at least a part of the first and second units, comprising: a first connection member attached to the first unit and having a first link part and a third link part; a second connection member coupled to the first connection member slidably along the axis of movement and attached to the second unit, the second connection member having a second link part and a fourth link part; a first resilient member connected to the first link part of the first connection member and the second link part of the second connection member for urging the first and second link parts to move away from each other; and a second resilient member connected to the third link part of the first connection member and the fourth link part of the second connection member for urging the third and fourth link parts to move away from each other, wherein the second resilient member lies closer to the second position than the first resilient member to avoid overlap of the second resilient member with the first resilient member.

In the slide type opening and closing device noted above, each of the first and second resilient members may comprise a torsion spring having a coil part and two extension parts extending from the coil part and respectively connected to the first connection member and the second connection member.

In the slide type opening and closing device as noted above, the coil part of the first resilient member may be disposed in a diametrically opposite relationship with the coil part of the second resilient member.

In the slide type opening and closing device as noted above, each of the first resilient member and the second resilient member may be provided with two coil parts and a connection part interconnecting the coil parts, the extension parts of each of the first and second resilient members extending from the respective coil parts.

In the slide type opening and closing device as noted above, each of the first connection member and the second connection member may be provided with two rollers, the extension parts of the first resilient member respectively connected to one of the rollers of the first connection member and one of the rollers of the second connection member, the extension parts of the second resilient member respectively connected to the other of the rollers of the first connection member and the other of the rollers of the second connection member.

In the slide type opening and closing device as noted above, the rollers of the first connection member may be arranged to face the second connection member and the rollers of the second connection member may be arranged to face the first connection member.

In the slide type opening and closing device as noted above, each of the first connection member and the second connection member may be provided with coupling pins to which the first resilient member and the second resilient member are connected, and the device may further comprise coupling members pivotably coupled to the respective coupling pins, the first resilient member and the second resilient member fixedly secured to the coupling members.

In the slide type opening and closing device as noted above, each of the first resilient member and the second resilient member may have coupling parts coupled to the coupling members and each of the coupling members may have a fixing part to which each of the coupling parts of the first resilient member and the second resilient member is affixed and a connection part provided with a coupling hole for pivotable engagement with one of the coupling pins of the first connection member and the second connection member.

In the slide type opening and closing device as noted above, the connection part of each of the coupling members may be further provided with an extension slot radially outwardly extending from the coupling hole and an entry mouth joined to the extension slot and flared radially outwardly, the extension slot of the connection part having a width smaller than the diameter of the coupling pins, the entry mouth of the connection part having a width at its widest part greater than the diameter of the coupling pins.

In the slide type opening and closing device as noted above, the fixing part of each of the coupling members may include a body having a coupling groove to which each of the coupling parts of the first resilient member and the second resilient member is fitted, and a cover capped on the body.

In the slide type opening and closing device as noted above, the cover of the fixing part may be ultrasonically fusion-bonded to the body.

In the slide type opening and closing device as noted above, the cover of the fixing part may have an coupling groove to which each of the coupling parts of the first resilient member and the second resilient member is fitted.

In the slide type opening and closing device as noted above, each of the coupling members may be injection-molded together with each of the coupling parts of the first resilient member and the second resilient member under a state that each of the coupling parts is inserted into a mold.

In the slide type opening and closing device as noted above, each of the first resilient member and the second resilient member may have a serpentine part formed of a wire extending in a zigzag shape and the coupling parts of each of the first resilient member and the second resilient member may be provided at opposite ends of the serpentine part.

In the slide type opening and closing device as noted above, each of the coupling parts of the first resilient member and the second resilient member may have a curved portion and two extension portions respectively extending from opposite ends of the curved portion.

According to another aspect of the present invention, there is provided a coupling member for use in a slide type opening and closing device for combining first and second units together and for causing the first and second units to move relatively with each other to thereby open or close at least a part of the first and second units, the slide type opening and closing device comprising: a first connection member attached to the first unit and provided with coupling pins; a second connection member coupled to the first connection member slidably with respect to the first connection member, the second connection member attached to the second unit and provided with coupling pins; and a resilient member urging the first connection member and the second connection member to move away from each other and having coupling parts, wherein the coupling member is adapted to connect the resilient member to the coupling pins of the first connection member and the coupling pins of the second connection member; and wherein the coupling member includes a fixing part to which each of the coupling parts of the resilient member is affixed and a connection part provided with a coupling hole for pivotable engagement with the coupling pins of the first connection member and the second connection member.

In the coupling member as noted above, the coupling member may be injection-molded together with each of the coupling parts of the resilient member under a state that each of the coupling parts is inserted into a mold.

In the coupling member as noted above, the fixing part of the coupling member may include a body having a coupling groove to which each of the coupling parts of the resilient member is fitted.

In the coupling member as noted above, the fixing part of the coupling member may further include a cover capped on the body.

In the coupling member as noted above, the cover of the fixing part may be connected to the body in a foldable manner.

In the coupling member as noted above, the cover of the fixing part may have an coupling groove to which each of the coupling parts of the resilient member is fitted.

In the coupling member as noted above, the body of the fixing part may further include a separation-proof lug for preventing each of the coupling parts of the resilient member from separation out of the coupling member.

In the coupling member as noted above, the connection part of the coupling member may be further provided with an extension slot radially outwardly extending from the coupling hole and an entry mouth joined to the extension slot and flared radially outwardly, the extension slot of the connection part having a width smaller than the diameter of the coupling pins, the entry mouth of the connection part having a width greater than the diameter of the coupling pins at its widest part.

### BRIEF DESCRIPTION OF THE DRAWINGS

The above and other features and advantages of the present invention will become apparent from the following description of preferred embodiments given in conjunction with the accompanying drawings, in which:

FIG. 1 is a perspective view showing a mobile phone or a portable electronic device with two units slidable between open and closed positions;

FIGS. 2 (a), (b) and (c) are respectively side, bottom and front views of a sliding mechanism for use in portable electronic devices in accordance with one embodiment of the present invention mobile phone;

FIGS. 3 (a) and (b) are respectively side and bottom views of the sliding mechanism of FIGS. 2 (a), (b) and (c), at a partially open position of the mobile phone;

FIGS. 4 (a) and (b) are respectively side and bottom views of the sliding mechanism of FIGS. 2 (a), (b) and (c), at a completely open position;

FIGS. 5 (a) and (b) show another embodiment of a spring and a coupling member of the spring for use in the sliding mechanism of FIGS. 2 (a), (b) and (c);

FIG. 6 shows another embodiment of the coupling member;

FIGS. 7 and 8 show further embodiments of the coupling member;

FIG. 9 illustrates a sliding mechanism for electronic devices for use in portable electronic devices utilizing the spring of FIG. 5(a) in accordance with an embodiment of the invention; and

FIG. 10 is a top view schematically illustrating a conventional sliding mechanism for use in a mobile phone.

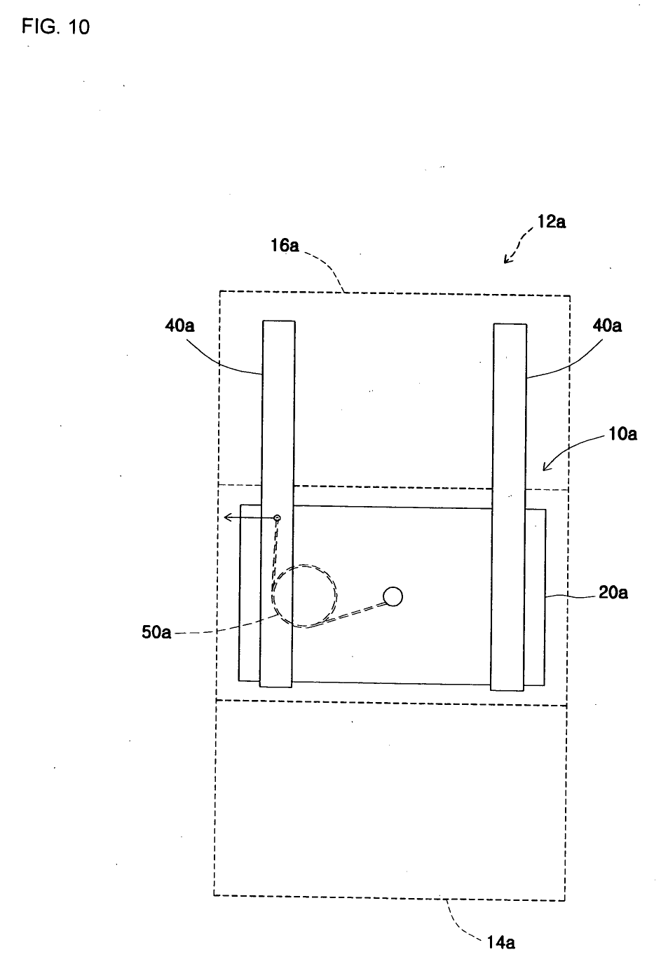

### DETAILED DESCRIPTION OF EMBODIMENTS OF THE INVENTION

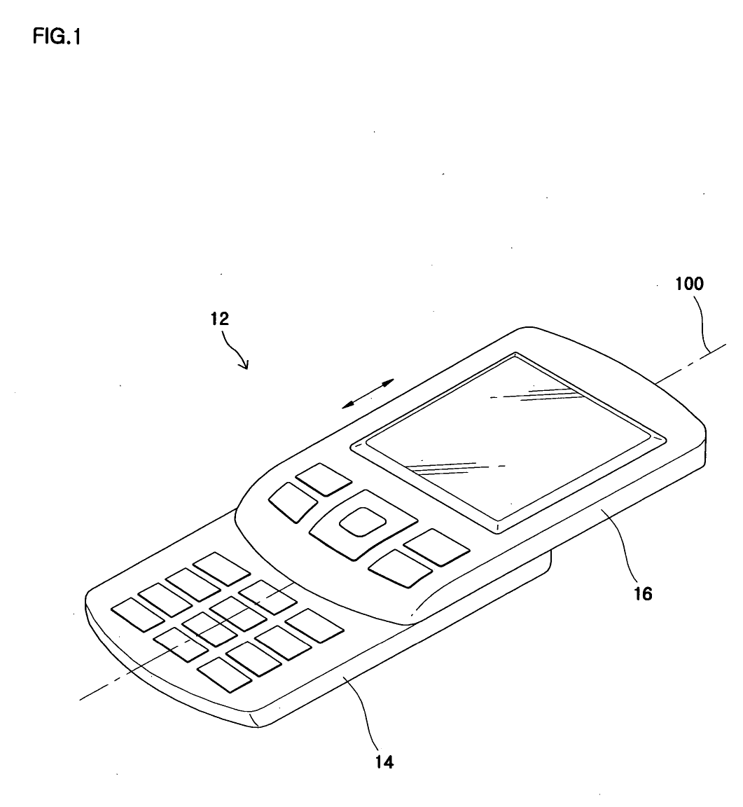

FIG. 1 illustrates a mobile phone that can incorporate various features and embodiments of the invention. In addition to mobile phones, the features and embodiments of the invention can be applied to other portable electronic devices including, but not limited to, hand-held computers, PDAs, calculators, electronic schedulers, electronic dictionaries, portable radio receivers, portable television receivers, portable telecommunication devices, etc.

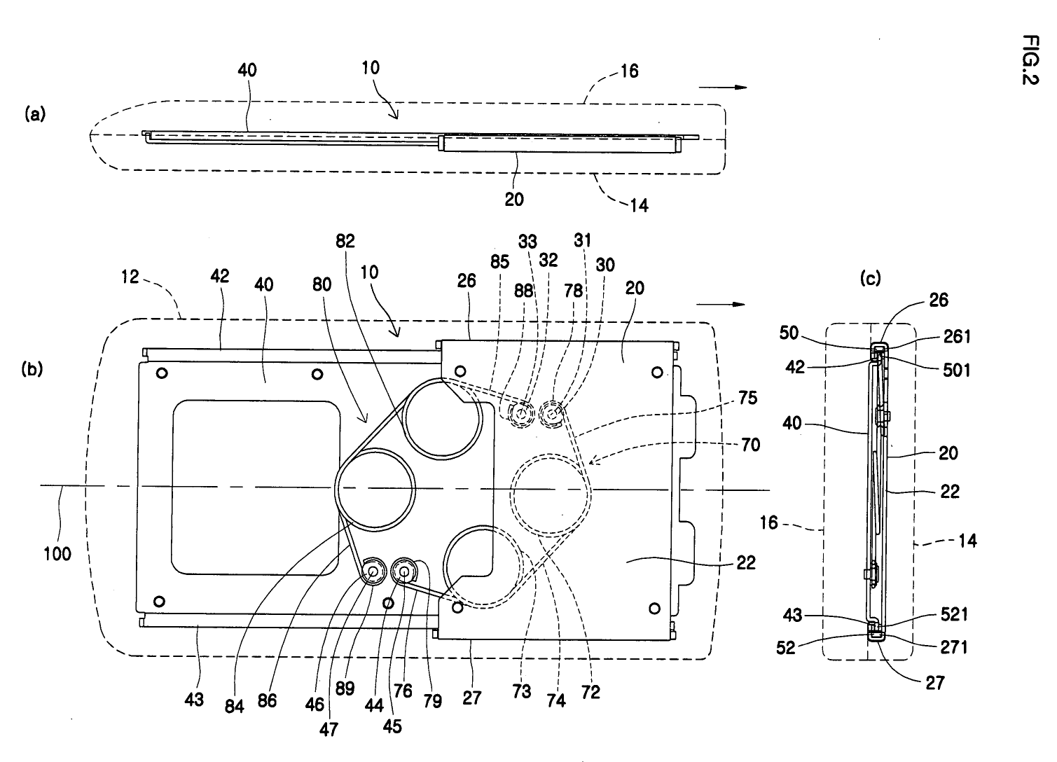

The illustrated mobile phone 12 includes a first unit 14 with a keypad and a second unit 16 with a liquid crystal display. As shown, a number of buttons may be disposed on the second unit 16. Referring collectively to FIGS. 1, 2 (a), 2 (b) and 2 (c), the first unit 14 and the second unit 16 are combined together one atop the other in such a manner that the second unit 16 can make a linear sliding movement with respect to the first unit 14 along an axis of movement 100 between a first open position (see FIG. 1) and a second closed position (see FIG. 2).

Referring to FIGS. 1, 2 (a), 2 (b) and 2 (c), one embodiment of the present invention includes a first connection member 20 attached to the first unit 14 of the mobile phone 12, a second connection member 40 attached to the second unit 16 of the mobile phone 12, and a first resilient member or spring 70 and a second resilient member or spring 80 disposed along the axis of movement 100. The first connection member 20, which is of a generally rectangular plate shape, includes a base plate 22 and first and second flank walls 26, 27 extending along the opposite sides of the base plate 22 in a parallel relationship with the axis of movement 100 and protruding a short distance toward the second unit 16.

First and second A-rollers 30, 32 are mounted to the base plate 22 by virtue of coupling pins 31, 33 so that they can face the second connection member 40. The first and second A-rollers 30, 32 are arranged closer to the first flank wall 26 than the second flank wall 27 and are adjoined to each other in a parallel relationship with the axis of movement 100. Coupled to the first A-roller 30 is a first A-coupling part 78 of the first spring 70 set forth below. Similarly, coupled to the second A-roller 32 is a second A-coupling part 88 of the second spring 80 described infra.

Elongated mounting grooves 261, 271 are respectively provided on the first and second flank walls 26, 27 in a confronting relationship with each other and in parallel to the axis of movement 100. First and second guides 50, 52 are inserted into and fitted to each of the elongated mounting grooves 261, 271. The first and second guides 50, 52 are respectively provided with first and second coupling guidance grooves 501, 521 that extend in a confronting relationship with each other and in parallel to the axis of movement 100. Slidably fitted to the first and second coupling guidance grooves 501, 521 are first and second insertion wings 42, 43 of the second connection member 40 explained later.

The second connection member 40 extends in a direction of the movement axis 100 and has a generally rectangular plate configuration. The length of the second connection member 40 in the direction of the movement axis 100 is greater than that of the first connection member 20. The second connection member 40 is kept in a spaced-apart confronting relationship with the base plate 22, thus providing a space for accommodation of the first spring 70 and the second spring 80.

At the opposite lateral sides of the second connection member 40 parallel to the movement axis 100, there are provided first and second insertion wings 42, 43, each of which is bent toward the first unit 14 of the mobile phone 12 and then curved laterally outwardly to extend a short distance. The first and second insertion wings 42, 43 are slidably inserted into the first and second coupling guidance grooves 501, 521 of the first connection member 20. The first and second insertion wings 42, 43 are slightly bent at their longitudinal ends to restrict a sliding movement stroke of the first connection member 20.

First and second B-rollers 44, 46 are mounted to the second connection member 40 by virtue of coupling pins 45, 47 so that they can face the first connection member 20. The first and second B-rollers 44, 46 are arranged closer to the second insertion wing 43 than the first insertion wing 42 and are adjoined to each other in a parallel relationship with the axis of movement 100. Coupled to the first B-roller 44 is a first B-coupling part 79 of the first spring 70 set forth below. Similarly, coupled to the second B-roller 46 is a second B-coupling part 89 of the second spring 80 described infra.

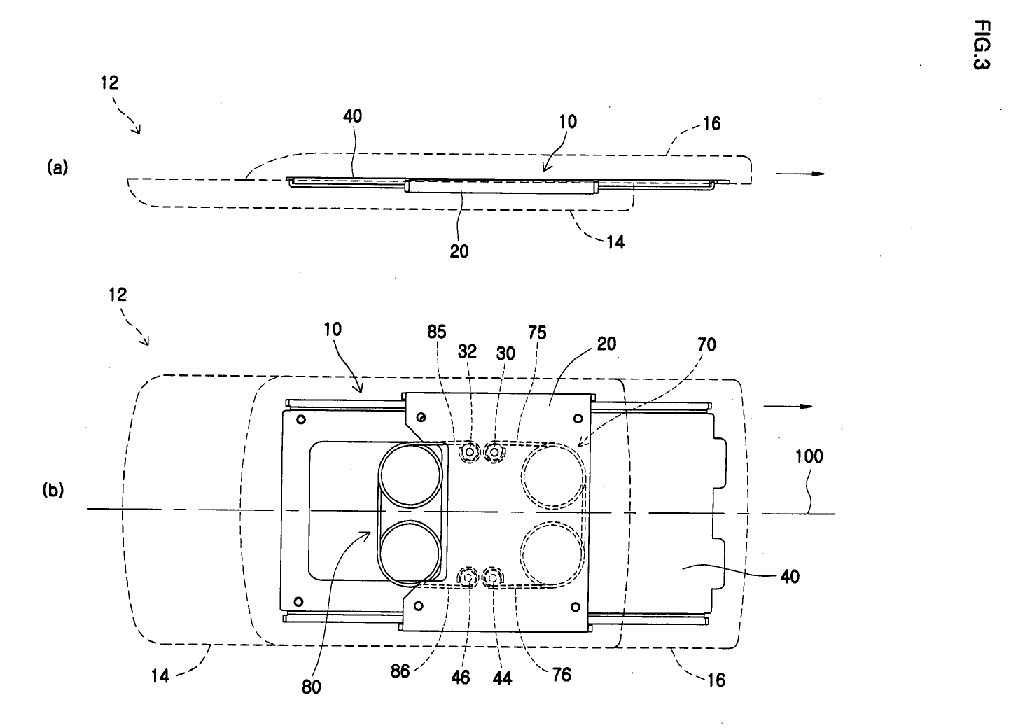

At the moment that the first connection member 20 lies in the midway point of the second connection member 40, the first and second A-rollers 30, 32 of the first connection member 20 come into exact alignment with the first and second B-rollers 44, 46 of the second connection member 40 with respect to the movement axis 100, as best shown in FIG. 3 (b).

Referring to FIGS. 2 (a) and (b), the first spring 70 is a torsion spring and includes a first A-coil part 72 and a first B-coil part 73, a first connection part 74 interconnecting the coil parts 72, 73 through a tangential contact with the coil parts 72, 73 in common, a first A-extension part 75 extending from the first A-coil part 72 and a first B-extension part 76 extending from the first B-coil part 73. The first A-extension part 75 and the first B-extension part 76 extend away from the first connection part 74. Preferably, the distance between the joining point of the first A-coil part 72 to the first A-extension part 75 and the joining point of the first B-coli part 73 to the first B-extension part 76 is substantially equal to the distance between the first A-roller 30 and the first B-roller 44 in the event that the first A-roller 30 of the first connection member 20 is placed closest to the first B-roller 44 of the second connection member 40, as illustrated in FIG. 3 (b).

The distal ends of the first A-extension part 75 and the first B-extension part 76 are rolled into a circular shape to provide a first A-coupling part 78 and a first B-coupling part 79, respectively. The first A-coupling part 78 and the first B-coupling part 79 are respectively fitted and coupled to the first A-roller 30 and the first B-roller 44. When coupled to the first A-roller 30 and the first B-roller 44, the first spring 70 exerts a resilient force so as to urge the first A-extension part 75 and the first B-extension part 76 to spread apart from each other.

The second spring 80 has the same configuration as the first spring 70, which will justify omission of detailed description in that regard. A second A-coupling part 88 and a second B-coupling part 89 of the second spring 80 are respectively fitted and coupled to a second A-roller 32 and a second B-roller 46. The first spring 70 and the second spring 80 are disposed in such a manner that the coil parts 72, 73 of the first spring 70 maintain a diametrically opposite relationship with respect to coil parts 82, 84 of the second spring 80. When coupled to the second A-roller 32 and the second B-roller 46, the second spring 80 exerts a resilient force so as to urge two extension parts 85, 86 to spread apart from each other.

The coupling pins 31, 45 of the first connection member 20 and the second connection member 40 to which the first spring 70 is connected at the coupling parts 78, 79 are adapted to serve as a first link part and a second link part, respectively. The first spring 70 exerts a force so as to urge the first and second link parts to move away from each other. The coupling pins 33, 47 of the first connection member 20 and the second connection member 40 to which the second spring 80 is connected at the coupling parts 88, 89 are adapted to serve as a third link part and a fourth link part, respectively. The second spring 80 exerts a force so as to urge the third and fourth link parts to move away from each other.

Operations of the afore-mentioned slide type opening and closing device will now be described in detail with reference to FIGS. 2 through 4. Referring to FIGS. 2 through 4, the mobile phone 12 is opened as the second connection member 40 moves to the right in the drawings with respect to the first connection member 20 but closed as the second connection member 40 moves to the left.

FIGS. 2 (a) and (b) show the mobile phone 12 remaining in a completely closed condition. Under this condition, the second connection member 40 lies at the leftmost position in the drawings with respect to the first connection member 20 and the first and second B-rollers 44, 46 of the second connection member 40 are placed at the left side of the first and second A-rollers 30, 32 of the first connection member 20. The extension parts 75, 76 of the first spring 70 and the extension parts 85, 86 of the second spring 80 have a tendency to spread apart from each other. Accordingly, the first spring 70 and the second spring 80 urge the second connection member 40 to move to the left with respect to the first connection member 20. Due to the fact that the mobile phone 12 is already in a completely closed condition, the second connection member 40 cannot move farther to the left with respect to the first connection member 20, thus stably keeping the mobile phone 12 in the closed condition.

In order to open the mobile phone 12 from the condition shown in FIGS. 2 (a) and (b), an external force should be applied in such a fashion as to push the second unit 16 in a direction indicated by an arrow, i.e., to the right in the drawings. This causes the second connection member 40 of the opening and closing device 10 to move to the right with respect to the first connection member 20, as a result of which the rollers 44, 46 of the second connection member 40 are caused to move rightward.

FIGS. 3 (a) and (b) show a condition that the second unit 16 of the mobile phone 12 continues to be pushed to the right and is brought into a neutral position where the rollers 44, 46 of the second connection member 40 remains in a closest confronting relationship with the rollers 30, 32 of the first connection member 20. Referring to FIGS. 3 (a) and (b), the first A-roller 30 of the first connection member 20 and the first B-roller 44 of the second connection member 40 are aligned on a line perpendicular to the movement axis 100. Likewise, the second A-roller 32 of the first connection member 20 and the second B-roller 46 of the second connection member 40 are aligned on a line perpendicular to the movement axis 100. In this state, no resilient biasing force is applied by the first spring 70 and the second spring 80, thus preventing the second connection member 40 from moving by itself to the left or right with respect to the first connection member 20. If the external pushing force is removed prior to the second unit 16 reaching the neutral position shown in FIGS. 3 (a) and (b), the second connection member 40 is automatically moved to the left by the resilient biasing force of the first spring 70 and the second spring 80, thus allowing the mobile phone 12 to be closed by itself.

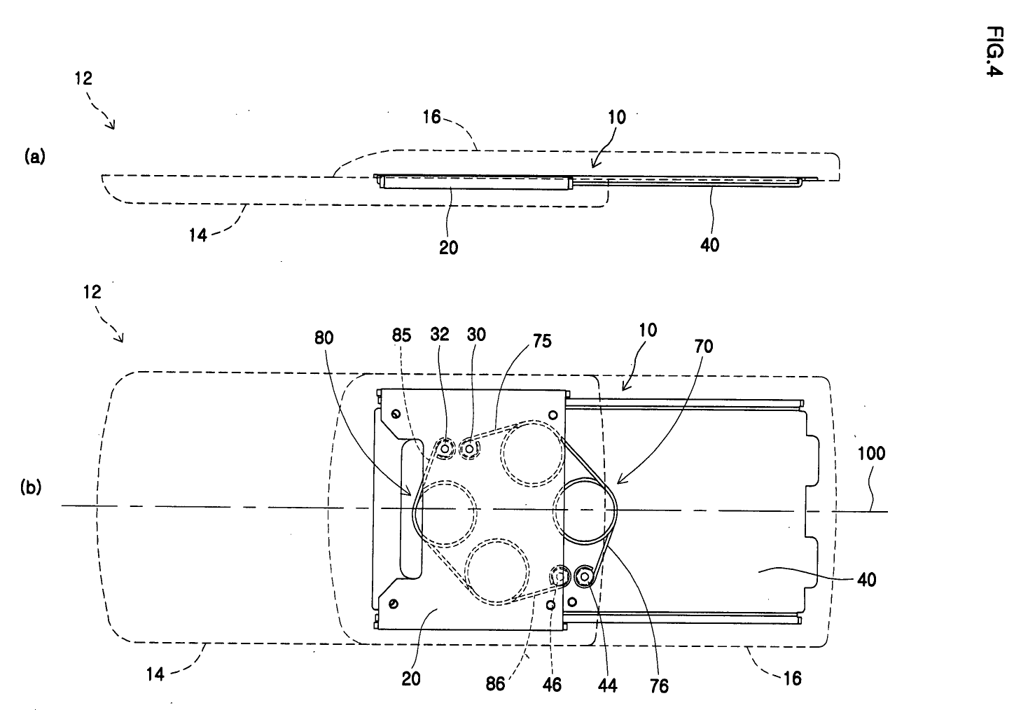

Under the condition illustrated in FIGS. 3 (a) and (b), if the second unit 16 is pushed farther to the right with respect to the first unit 14 in an effort to further open the mobile phone 12, the second connection member 40 is caused to move rightward with respect to the first connection member 20, as a result of which the rollers 44, 46 of the second connection member 40 move to the right and lie at the right side of the rollers 30, 32 of the first connection member 20, as illustrated in FIGS. 4 (a) and (b). In this state, the first spring 70 and the second spring 80 exert resilient forces so as to urge the second connection member 40 to move to the right with respect to the first connection member 20. This enables the second connection member 40 to move rightward by itself with respect to the first connection member 20, eventually stopping at the rightmost position.

Referring to FIGS. 4 (a) and (b), it can be seen that the mobile phone 12 is in a completely opened condition. At this time, the second connection member 40 lies at a rightmost position in the drawings with respect to the first connection member 20 and the first and second B-rollers 44, 46 of the second connection member 40 are placed at the right side of the first and second A-rollers 30, 32 of the first connection member 20. The extension parts 75, 76 of the first spring 70 and the extension parts 85, 86 of the second spring 80 have a tendency to spread apart from each other. Accordingly, the first spring 70 and the second spring 80 urge the second connection member 40 to move to the right with respect to the first connection member 20. Due to the fact that the mobile phone 12 is already in a completely opened condition, the second connection member 40 cannot move farther to the right with respect to the first connection member 20, thus stably keeping the mobile phone 12 in the opened condition. The process of closing the mobile phone 12 from the opened condition is opposite to the opening process as set forth hereinabove, for the reason of which no description will be offered in that regard.

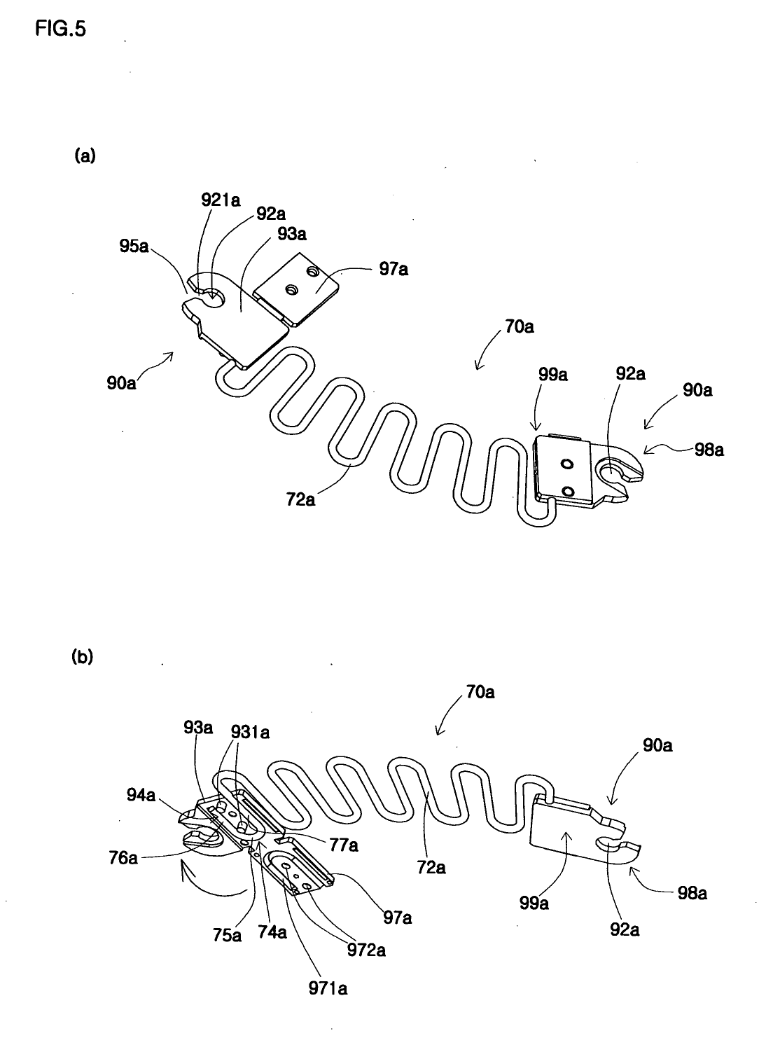

FIGS. 5 (a) and (b) show another embodiment of the springs or resilient members employed in the slide type opening and closing device shown in FIGS. 2 (a), (b) and (c) and also shows an coupling member for coupling the resilient members to the individual connection members. Referring to FIGS. 5 (a) and (b), a spring 70a according to this embodiment has a serpentine part 72a formed of a wire extending in a zigzag or undulating configuration. The serpentine part 72a is provided at their opposite ends with coupling parts 74a respectively coupled to coupling members 90a. In the drawings, only one of the coupling parts 74a is illustrated for the purpose of simplicity. Each of the coupling parts 74a has a curved portion 75a and two extension portions 76a, 77a respectively extending in parallel from opposite ends of the curved portion 75a. Each of the coupling parts 74a is fitted to a coupling groove 94a of each of the coupling members 90a set forth later.

Each of the coupling members 90a has a fixing part 99a to which each of the coupling parts 74a of the spring 70a is affixed and a connection part 98a provided with a coupling hole 92a. The fixing part 99a includes a body 93a having a coupling groove 94a and a cover 97a joined to the body 93a. The connection part 98a extends from body 93a. The coupling groove 94a is so shaped as to receive and retain each of the coupling parts 74a of the spring 70a. The cover 97a is ultrasonically fusion-bonded to the body 93a in such a manner that it can be folded over the body 93a and cover up the coupling groove 94a of the body 93a. The cover 97a has a coupling groove 971a to which each of the coupling parts 74a of the spring 70a can be fitted and insertion holes 972a into which bosses 931a of the body 93a are inserted. The coupling hole 92a is of a circular shape and has a size great enough to receive each of the coupling pins 31, 33, 45, 47 (see FIG. 2).

Under the state that each of the coupling pins 31, 33, 45, 47 is fitted through the coupling hole 92a, the coupling members 90a can make a free rotation about each of the coupling pins 31, 33, 45, 47. The connection part 98a is further provided with an extension slot 921a joined to the coupling hole 92a and radially outwardly extending from the coupling hole 92a. The extension slot 921a provides access to the coupling hole 92a. An entry mouth 95a is joined to a radially outer end of the extension slot 921a and has a radially outwardly flared shape. The extension slot 921a has a width smaller than the diameter of the coupling pins 31, 33, 45, 47 (see FIG. 2) and the entry mouth 95a has a width greater than the diameter of the coupling pins 31, 33, 45, 47 at its widest part. This ensures that each of the coupling pins 31, 33, 45, 47 is inserted into the coupling hole 92a of each of the coupling members 90a through the entry mouth 95a and then the extension slot 921a, at which time the extension slot 921a can be elastically enlarged to receive each of the coupling pins 31, 33, 45, 47. In this manner, each of the coupling members 90a is coupled to a respective one of the coupling pins 31, 33, 45, 47 of the first connection member 20 and the second connection member 40 shown in FIG. 2. Thank to the fact that the spring 70a is not directly coupled to the first connection member 20 and the second connection member 40 but coupled to them by means of the coupling members 90a, it becomes possible to reduce noise and damage which would otherwise created in the coupling parts.

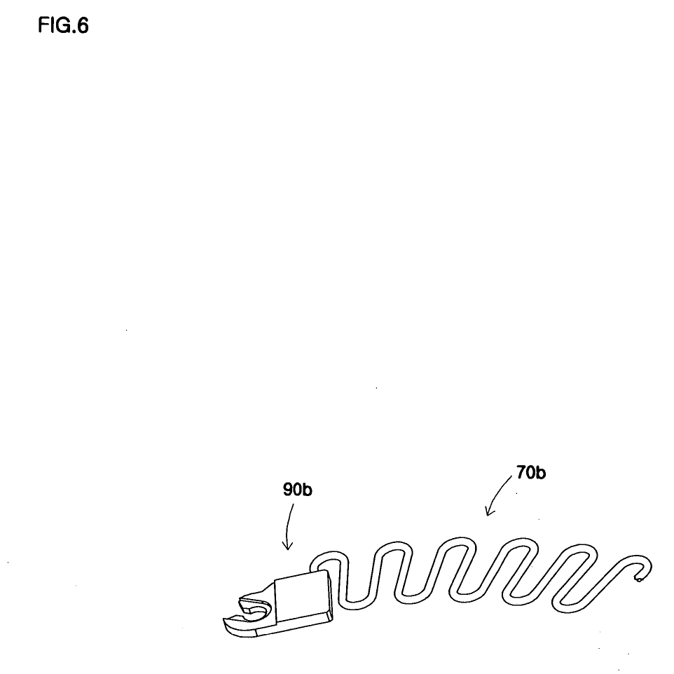

FIG. 6 shows another embodiment of the coupling member shown in FIGS. 5 (a) and (b). The coupling member 90b illustrated in FIG. 6 is injection-molded together with each of the coupling parts 74a (see FIG. 5) of the spring 70b under a state that each of the coupling parts 74a is inserted into a mold.

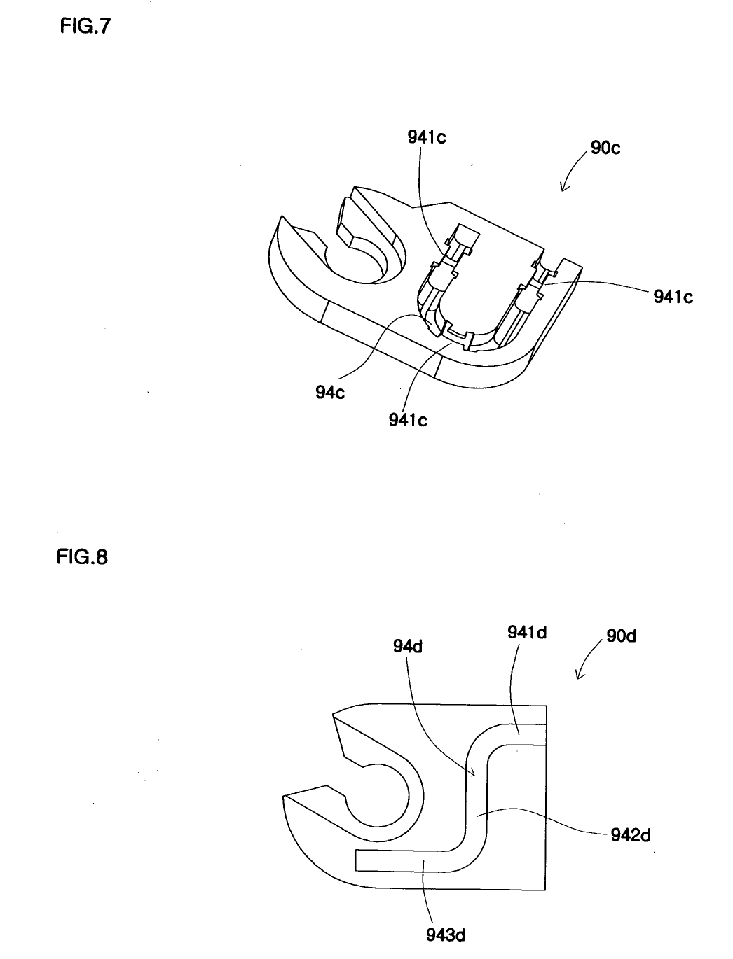

FIG. 7 shows a further embodiment of the coupling member shown in FIGS. 5 (a) and (b). Referring to FIG. 7, the coupling member 90c has one coupling groove 94c and three separation-proof lugs 941c for preventing each of the coupling parts 74a (see FIG. 5) of the spring 70a from any unwanted separation out of the coupling member.

FIG. 8 shows a still further embodiment of the coupling member shown in FIGS. 5 (a) and (b). Referring to FIG. 8, the coupling member 90d has a coupling groove 94d that is composed of a first extension part 941d, a second extension part 942d curved substantially at a right angle from the first extension part 941d and a third extension part 943d bent generally at a right angle from the second extension part 942d and running in an opposite direction to the first extension part 941d.

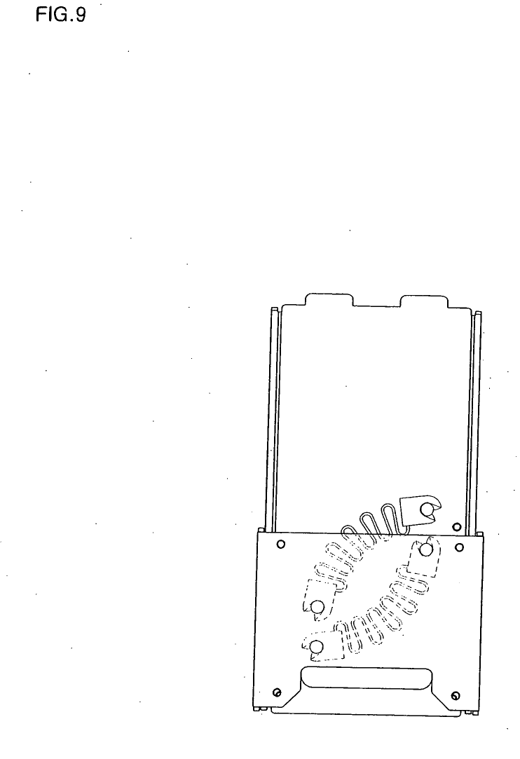

FIG. 9 illustrates an embodiment of a sliding mechanism using the resilient member or spring 72(a) of FIGS. 5(a) and (b). In the illustrated embodiment, the sliding mechanism is in one position corresponding to either of the open or closed positions of the sliding mechanism of FIGS. 2-4. The sliding mechanism of FIG. 9 operates generally in the same manner as that of FIGS. 2-4 except that the spring 72(a) is used. One of ordinary skill in the art will appreciate the operation of the sliding mechanism FIG. 9 in view of the above descriptions of the sliding mechanism of FIGS. 2-4.

While the foregoing description has been made for an exemplary case that the slide type opening and closing device is applied to a mobile phone, the present invention shall not be limited to this particular application but may find many other applications wherein a couple of mutually combined units are opened and closed in a sliding manner.

Although the invention has been described in terms of certain embodiments only, it will be apparent to those skilled in the art that various changes or modifications may be made thereto within the scope of the invention defined by the appended claims.

What is claimed is:

1. A device comprising a sliding mechanism configured to interconnect a first unit and a second unit such that the first and second units can slide with reference to the other, wherein the sliding mechanism comprises:
a first sliding member configured to be secured to the first unit,
a second sliding member configured to be secured to the second unit, the second sliding member slidably engaged with the first sliding member and slidable relative to the first sliding member between a first position and a second position;
a first spring comprising a first end secured to the first sliding member and a second end secured to the second sliding member, the first spring configured to exert force on the first and second sliding members to spontaneously move away from each other; and
a second spring comprising a first end secured to the first sliding member and a second end secured to the second sliding member, the second spring configured to exert force on the first and second sliding members to spontaneously move away from each other,
wherein there is a third position between the first and second positions, wherein the first and second springs are arranged so as to force the second sliding member to spontaneously move toward the first position when the second sliding member is located between the first and third position.

2. The device of claim 1, wherein the first spring second springs are configured and arranged such that no portions of the first and second springs overlap as the second sliding member moves relative to the first sliding member between the first and second positions.

3. The device of claim 1, wherein the first spring and the second spring are configured and arranged such that the first and second springs are on substantially the same plane as the second sliding member moves relative to the first sliding member between the first and second positions.

4. The device of claim 1, wherein the first and second springs are arranged such that the first spring is closer to the first position than the second spring.

5. The device of claim 1, wherein the first spring is arranged such that the first end of the first spring is closer to the first position than the second end of the first spring.

6. The device of claim 1, wherein at least one of the first and second springs comprises a torsion spring.

7. The device of claim 6, wherein the torsion spring comprises at least two coils.

8. The device of claim 1, wherein the first and second springs are arranged so as to force the second sliding member to spontaneously move toward the second position when the second sliding member is located between the second and third position.

9. The device of claim 1, wherein one of the first and second sliding members comprises a rail, and the other of the first and second sliding members comprises a guide groove configured to slidably engage with the rail.

10. The device of claim 1, wherein the first sliding member comprises a first edge and a second edge substantially parallel to the first edge, wherein the second sliding member comprises a first edge and a second edge parallel to the first edge of the second sliding member, wherein the first and second sliding members are engaged such that the first edge of the second sliding member is substantially parallel to the first edge of the first sliding member and that the first edge of the second sliding member is located closer to the first edge of the first sliding member.

11. The device of claim 10, wherein the first end of the first spring is secured to the first sliding member at a position closer to the first edge of the first sliding member than to the second edge of the first sliding member, and wherein the second end of the first spring is secured to the second sliding member at a position closer to the second edge of the second sliding member than to the first edge of the second sliding member.

12. The device of claim 11, wherein the first end of the second spring is secured to the first sliding member at a position closer to the first edge of the first sliding member than to the second edge of the first sliding member, and wherein the second end of the second spring is secured to the second sliding member at a position closer to the second edge of the second sliding member than to the first edge of the second sliding member.

13. The device of claim 1, wherein the first end of the first spring is secured to the first sliding member, wherein the first spring is rotatable about an axis substantially perpendicular to a plane on which the second sliding member is slidable while the first end does not move relative to the first sliding member on the plane.

14. The device of claim 13, wherein the axis is located in the vicinity of the first end of the first spring.

15. The device of claim 1, wherein the first end of the first spring is secured to the first sliding member via a coupler, wherein the first end is secured to coupler, wherein the first sliding member comprises a post protruding in a direction substantially perpendicular to a plane on which the second sliding member is slidable relative to the first sliding member, and wherein the coupler is engaged with the post and rotatable about the direction.

16. The device of claim 1, wherein at least one of the first and second springs comprises an undulating portion.

17. The device of claim 16, wherein the undulating portion is generally in curved configurations when the second sliding member is at the first or second positions, and wherein the curved configurations are curved generally in opposite directions.

18. The device of claim 1, wherein the device comprises a portable electronic device, wherein at least one of the first and second units comprises a display, and wherein at least one of the first and second units comprises an information input device.

19. The device of claim 1, wherein the device comprises a portable electronic device selected from the group consisting of a wireless internet device, a mobile phone, a wireless email receiver, a radio receiver, a television receiver, a calculator, an electronic dictionary or encyclopedia, a PDA and a hand-held computer.

20. A method of operating a device, comprising:
providing the device of claim 1, there is a third position between the first position and second position; and
sliding the second unit with reference to the first unit in a first direction, whereby the second sliding member slides with reference to the first sliding member away from the first position and toward the second position,
wherein after the sliding if the second sliding member is located between the first position and the third position, the second sliding member spontaneously slides to the first position,
wherein after the sliding if the second sliding member is located between the third position and the second position, the second sliding member spontaneously slides to the second position.

21. The method of claim 20, wherein the first position corresponds to a closed position of the device, and wherein the second position corresponds to an open position of the device.

22. The method of claim 20, further comprising:
sliding the second unit with reference to the first unit in a second direction opposing the first direction, whereby the second sliding member slides away from the second position and toward the first position,
wherein after the sliding if the second sliding member is located between the third position and the second position, the second sliding member spontaneously slides to the second position,
wherein after the sliding if the second sliding member is located between the first position and the third position, the second sliding member spontaneously slides to the first position.

23. A portable electronic device, comprising:
a first electronic unit;
a second electronic unit slidably connected to the first electronic unit, wherein at least one of the first and second electronic units comprises a display, and wherein at least one of the first and second electronic units comprises an information input device; and
a sliding mechanism interconnecting the first and second electronic units, the sliding mechanism comprising:
a first sliding member secured to the first electronic unit,
a second sliding member secured to the second electronic unit, the second sliding member slidably engaged with the first sliding member and slidable relative to the first sliding member between a first position and a second position,
a first spring comprising a first end secured to the first sliding member and a second end secured to the second sliding member, the first spring configured to exert force on the first and second sliding members to spontaneously move away from each other, and
a second spring comprising a first end secured to the first sliding member and a second end secured to the second sliding member, the second spring configured to exert force on the first and second sliding members to spontaneously move away from each other.
